(19) United States
(12) Patent Application Publication
(10) Pub. No.: US 2002/0178262 A1
(43) Pub. Date: Nov. 28, 2002

(54) System and method for dynamic load balancing

(76) Inventors: David Bonnell, Cairns (AU); Mark Sterin, Missouri City, TX (US)

Correspondence Address: WONG, CABELLO, LUTSCH, RUTHERFORD & BRUCCULERI,, P.C., 20333 SH 249, SUITE 600, HOUSTON, TX, 77070, US

(21) Appl. No.: 10/152,509

(22) Filed: May 21, 2002

Related U.S. Application Data
(60) Provisional application No. 60/292,908, filed on May 22, 2001.

(51) Int. Cl. G06F 15/173; G06F 9/00

(52) U.S. Cl. 709/225; 709/105

(57) ABSTRACT

A method, system, and medium for dynamic load balancing of a multi-domain server are provided. A first computer system includes a plurality of domains and a plurality of system processor boards. A management console is coupled to the first computer system and is configurable to monitor the plurality of domains. An agent is configurable to gather a first set of information relating to the domains. The agent includes one or more computer programs that are configured to be executed on the first computer system. The agent is configurable to automatically migrate one or more of the plurality of system processor boards among the plurality of domains in response to the first set of gathered information relating to the domains.

### PRIORITY DATA

This application claims benefit of priority of provisional application Serial No. 60/292,908 titled “System and Method for Dynamic Load Balancing” filed May 22, 2001, whose inventor is David Bonnell.

### BACKGROUND OF THE INVENTION

1. Field of the Invention

The present invention relates to computer software, and more particularly to dynamic load balancing as demand for CPU resources within an enterprise computer system changes.

2. Description of the Related Art

The data processing resources of business organizations are increasingly taking the form of a distributed computing environment in which data and processing are dispersed over a network comprising many interconnected, heterogeneous, geographically remote computers. Such a computing environment is commonly referred to as an enterprise computing environment, or simply an enterprise. As used herein, an “enterprise” refers to a network comprising two or more computer systems. Managers of an enterprise often employ software packages known as enterprise management systems to monitor, analyze, and manage the resources of the enterprise. For example, an enterprise management system might include a software agent on an individual computer system for the monitoring of particular resources such as CPU usage or disk access. As used herein, an “agent”, “agent application,” or “software agent” is a computer program that is configured to monitor and/or manage the hardware and/or software resources of one or more computer systems. An “agent” may be referred to as a core component of an enterprise management system architecture. U.S. Pat. No. 5,655,081 discloses one example of an agent-based enterprise management system.

Load balancing across the enterprise computing environment may require constant monitoring and changing to optimize the available processors or boards based upon the current demands presented to the enterprise computing environment by users. Thus, in the absence of automation, load balancing may be a time-intensive endeavor. Additionally, due to the constantly changing needs of the user community in the field of enterprise computing environment, static automation alone may not provide the best solution even over the course of one business day.

For the foregoing reasons, there is a need for a system and method for a load balancing system for enterprise management which dynamically reacts to changing user needs.

### SUMMARY OF THE INVENTION

The present invention provides various embodiments of a method, system, and medium for dynamic load balancing a plurality of system processor boards across a plurality of domains in a first computer system. A management console may be coupled to the first computer system. An agent may operate under the direction of the management console and may monitor the plurality of domains on behalf of the management console. The agent may gather a first set of information relating to the domains and this information may be displayed on the management console. One or more of the plurality of system processor boards among the plurality of domains may be automatically migrated in response to the gathered information relating to the domains.

The gathered information may include a CPU load on the first computer system from each of the plurality of domains. Alternatively, or in addition, the gathered information may include a rolling average CPU load on the first computer system from each of the plurality of domains. The agent may include one or more knowledge modules. Each knowledge module may be configured to gather part of the information relating to the domains.

The gathered information may include a prioritized list of a subset of recipient domains of the plurality of domains. Additionally, the gathered information may include a prioritized list of a subset of donor domains of the plurality of domains.

The automatic migration of one or more of the plurality of system processor boards among the plurality of domains may include: (a) selecting a highest priority available system processor board from the subset of donor domains; (b) moving the selected highest priority available system processor board from the subset of donor domains to a highest priority domain in the subset of recipient domains; (c) repeating steps (a) and (b) until supply of available system processor boards from the subset of donor domains is exhausted.

The automatic migration of one or more of the plurality of system processor boards among the plurality of domains may include: (a) selecting a highest priority available system processor board from the subset of donor domains; (b) moving the selected highest priority available system processor board from the subset of donor domains to a highest priority domain in the subset of recipient domains; (c) repeating steps (a) and (b) until demand for system processor boards in the subset of recipient domains is exhausted.

The plurality of domains may be user configurable. The user configuration may include setting characteristics for each of the plurality of domains. The characteristics may include one or more of: a priority; an eligibility for load balancing; a maximum number of system processor boards; a threshold average CPU load on the first computer system; a minimum time interval between migrations of a system processor board.

### BRIEF DESCRIPTION OF THE DRAWINGS

A better understanding of the present invention can be obtained when the following detailed description of several embodiments is considered in conjunction with the following drawings, in which:

FIG. 1a illustrates a high level block diagram of a computer system which is suitable for implementing a dynamic load balancing system and method according to one embodiment;

FIG. 1b further illustrates a computer system which is suitable for implementing a dynamic load balancing system and method according to one embodiment;

FIG. 2 illustrates an enterprise computing environment which is suitable for implementing a dynamic load balancing system and method according to one embodiment;

FIG. 3 is a block diagram which illustrates an overview of the dynamic load balancing system and method according to one embodiment;

FIG. 4 is a block diagram which illustrates an overview of an agent according to one embodiment;

FIG. 5 is a flowchart illustrating dynamic load balancing a plurality of system processor boards across a plurality of domains in a first computer system according to one embodiment;

FIG. 6 illustrates physical relationships of an automated domain recovery/reconfiguration (ADR) knowledge module (KM) according to one embodiment;

FIG. 7 illustrates logical relationships of an automated domain recovery/reconfiguration (ADR) knowledge module (KM) according to one embodiment;

FIG. 8 illustrates a configuration use case showing a first flow of events according to one embodiment;

FIG. 9 illustrates a KM tiered use case showing a second flow of events according to one embodiment; and

FIG. 10 illustrates an enterprise management system including mid-level manager agents according to one embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION OF SEVERAL EMBODIMENTS

### Incorporation by Reference

U.S. provisional application Serial No. 60/292,908 titled “System and Method for Dynamic Load Balancing” filed May 22, 2001, whose inventor is David Bonnell, is hereby incorporated by reference in its entirety as though fully and completely set forth herein.

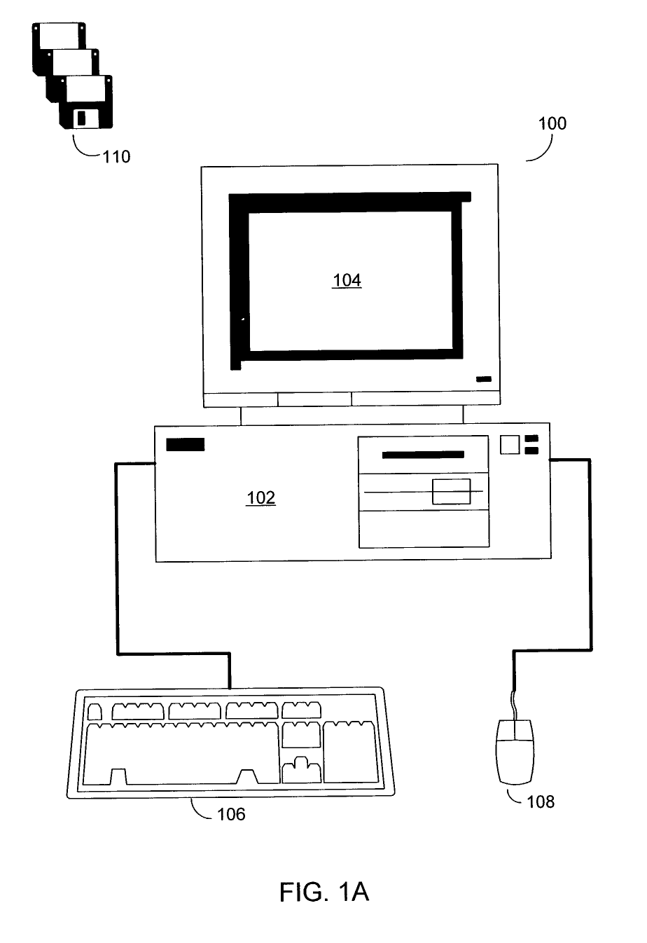

### FIG. 1a—A Typical Computer System

FIG. 1a is a high level block diagram illustrating a typical, general-purpose computer system 100 which is suitable for implementing a dynamic load balancing system and method according to one embodiment. The computer system 100 typically comprises components such as computing hardware 102, a display device such as a monitor 104, an input device such as a keyboard 106, and optionally an input device such as a mouse 108. The computer system 100 is operable to execute computer programs which may be stored on disks 110 or in computing hardware 102. In one embodiment, the disks 110 comprise an installation medium. In various embodiments, the computer system 100 may comprise a desktop computer, a laptop computer, a palmtop computer, a network computer, a personal digital assistant (PDA), an embedded device, a smart phone, or any other suitable computing device. In general, the term “computer system” may be broadly defined to encompass any device having a processor which executes instructions from a memory medium.

### FIG. 1b—Computing Hardware of a Typical Computer System

FIG. 1b is a block diagram illustrating the computing hardware 102 of a typical, general-purpose computer system 100 (as shown in FIG. 1a) which is suitable for implementing a dynamic load balancing system and method according to one embodiment. The computing hardware 102 may include at least one central processing unit (CPU) or other processor(s) 122. The CPU 122 may be configured to execute program instructions which implement the dynamic load balancing system and method as described herein. The program instructions may comprise a software program which may operate to automatically migrate one or more of the plurality of system processor boards among the plurality of domains in response to the first set of gathered information relating to the domains. The CPU 122 is preferably coupled to a memory medium 124.

As used herein, the term “memory medium” includes a non-volatile medium, e.g., a magnetic medium, hard disk, or optical storage; a volatile medium, such as computer system memory, e.g., random access memory (RAM) such as DRAM, SDRAM, SRAM, EDO RAM, Rambus RAM, etc.; or an installation medium, such as CD-ROM, floppy disks, or a removable disk, on which computer programs are stored for loading into the computer system. The term “memory medium” may also include other types of memory and is used synonymously with “memory”. The memory medium 124 may therefore store program instructions and/or data which implement the dynamic load balancing system and method described herein. Furthermore, the memory medium 124 may be utilized to install the program instructions and/or data. In a further embodiment, the memory medium 124 may be comprised in a second computer system which is coupled to the computer system 100 through a network 128. In this instance, the second computer system may operate to provide the program instructions stored in the memory medium 124 through the network 128 to the computer system 100 for execution.

The CPU 122 may also be coupled through an input/output bus 120 to one or more input/output devices that may include, but are not limited to, a display device such as monitor 104, a pointing device such as mouse 108, keyboard 106, a track ball, a microphone, a touch-sensitive display, a magnetic or paper tape reader, a tablet, a stylus, a voice recognizer, a handwriting recognizer, a printer, a plotter, a scanner, and any other devices for input and/or output. The computer system 100 may acquire program instructions and/or data for implementing the dynamic load balancing system and method as described herein through the input/output bus 120.

The CPU 122 may include a network interface device 128 for coupling to a network. The network may be representative of various types of possible networks: for example, a local area network (LAN), a wide area network (WAN), or the Internet. The dynamic load balancing system and method as described herein may therefore be implemented on a plurality of heterogeneous or homogeneous networked computer systems such as computer system 100 through one or more networks. Each computer system 100 may acquire program instructions and/or data for implementing the dynamic load balancing system and method as described herein over the network.

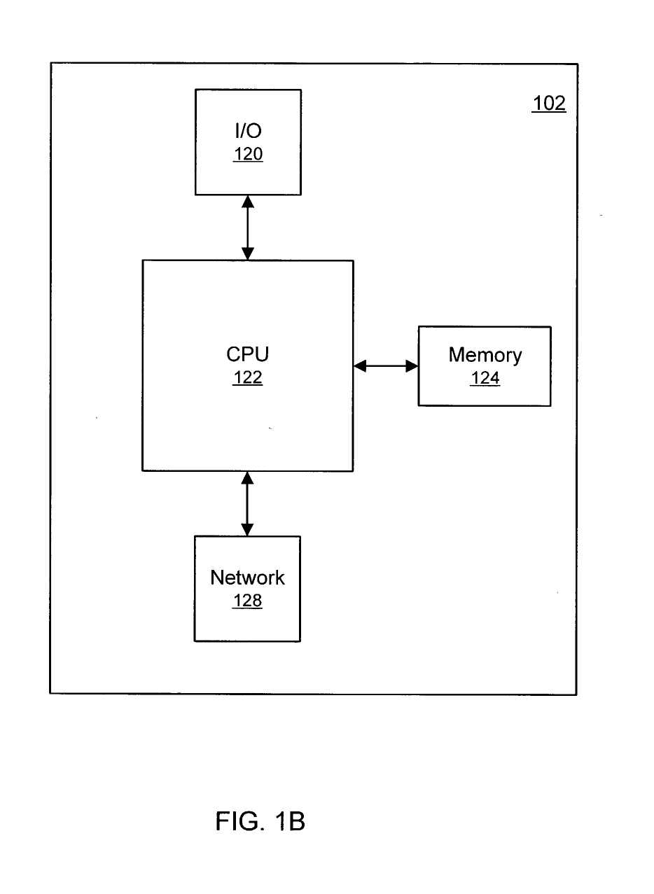

### FIG. 2—A Typical Enterprise Computing Environment

FIG. 2 illustrates an enterprise computing environment 200 according to one embodiment. An enterprise 200 may comprise a plurality of computer systems such as computer system 100 (as shown in FIG. 1a) which are interconnected through one or more networks. Although one particular embodiment is shown in FIG. 2, the enterprise 200 may comprise a variety of heterogeneous computer systems and networks which are interconnected in a variety of ways and which run a variety of software applications.

One or more local area networks (LANs) 204 may be included in the enterprise 200. A LAN 204 is a network that spans a relatively small area. Typically, a LAN 204 is confined to a single building or group of buildings. Each node (i.e., individual computer system or device) on a LAN 204 preferably has its own CPU with which it executes computer programs, and often each node is also able to access data and devices anywhere on the LAN 204. The LAN 204 thus allows many users to share devices (e.g., printers) as well as data stored on file servers. The LAN 204 may be characterized by any of a variety of types of topology (i.e., the geometric arrangement of devices on the network), of protocols (i.e., the rules and encoding specifications for sending data, and whether the network uses a peer-to-peer or client/server architecture), and of media (e.g., twisted-pair wire, coaxial cables, fiber optic cables, radio waves). FIG. 2 illustrates an enterprise 200 including one LAN 204. However, the enterprise 200 may include a plurality of LANs 204 which are coupled to one another through a wide area network (WAN) 202. A WAN 202 is a network that spans a relatively large geographical area.

Each LAN 204 may comprise a plurality of interconnected computer systems or at least one computer system and at least one other device. Computer systems and devices which may be interconnected through the LAN 204 may include, for example, one or more of a workstation 210a, a personal computer 212a, a laptop or notebook computer system 214, a server computer system 216, or a network printer 218. An example LAN 204 illustrated in FIG. 2 comprises one of each of these computer systems 210a, 212a, 214, and 216 and one printer 218. Each of the computer systems 210a, 212a, 214, and 216 is preferably an example of the typical computer system 100 as illustrated in FIGS. 1a and 1b. The LAN 204 may be coupled to other computer systems and/or other devices and/or other LANs 204 through a WAN 202.

A mainframe computer system 220 may optionally be coupled to the enterprise 200. As shown in FIG. 2, the mainframe 220 is coupled to the enterprise 200 through the WAN 202, but alternatively the mainframe 220 may be coupled to the enterprise 200 through a LAN 204. As shown in FIG. 2, the mainframe 220 is coupled to a storage device or file server 224 and mainframe terminals 222a, 222b, and 222c. The mainframe terminals 222a, 222b, and 222c may access data stored in the storage device or file server 224 coupled to or comprised in the mainframe computer system 220.

The enterprise 200 may also comprise one or more computer systems which are connected to the enterprise 200 through the WAN 202: as illustrated, a workstation 210b and a personal computer 212b. In other words, the enterprise 200 may optionally include one or more computer systems which are not coupled to the enterprise 200 through a LAN 204. For example, the enterprise 200 may include computer systems which are geographically remote and connected to the enterprise 200 through the Internet.

When the computer programs 110 are executed on one or more computer systems such as computer system 100, the dynamic load balancing system may be operable to monitor, analyze, and/or balance the computer programs, processes, and resources of the enterprise 200. Typically, each computer system 100 in the enterprise 200 executes or runs a plurality of software applications or processes. Each software application or process consumes a portion of the resources of a computer system and/or network: for example, CPU time, system memory such as RAM, nonvolatile memory such as a hard disk, network bandwidth, and input/output (I/O). The dynamic load balancing system and method of one embodiment permits users to monitor, analyze, and/or balance resource usage on heterogeneous computer systems 100 across the enterprise 200.

U.S. Pat. No. 5,655,081, titled “System for Monitoring and Managing Computer Resources and Applications Across a Distributed Environment Using an Intelligent Autonomous Agent Architecture”, which discloses an enterprise management system and method, is hereby incorporated by reference as though fully and completely set forth herein.

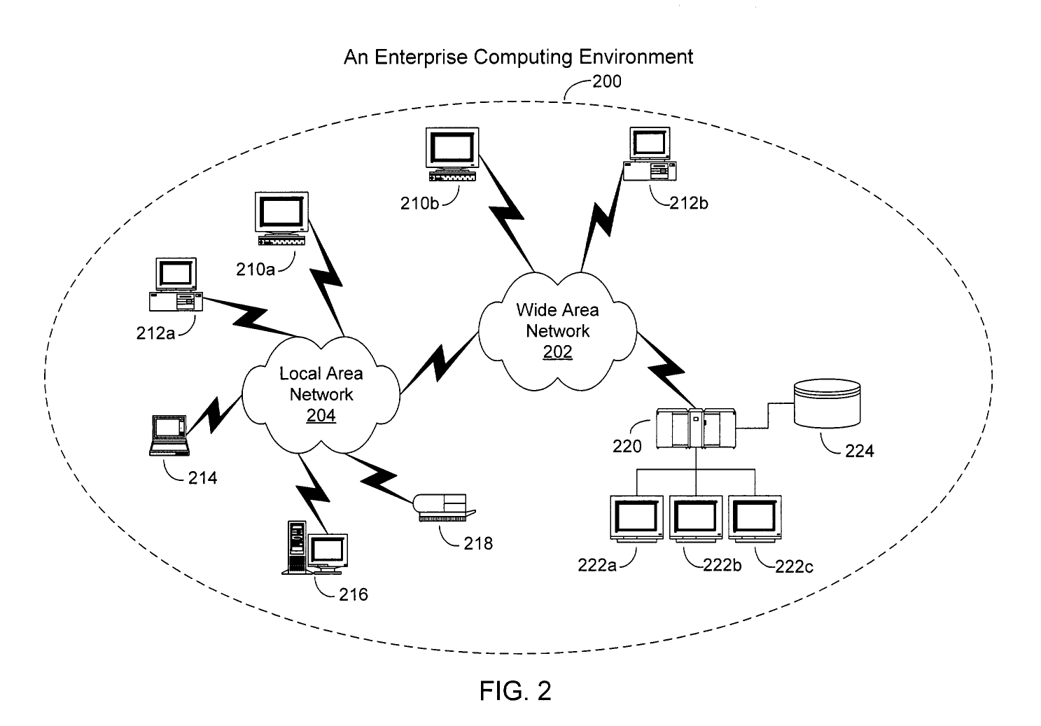

### FIG. 3—Overview of the Enterprise Management System

FIG. 3 illustrates one embodiment of an overview of software components that may comprise the enterprise management system. In one embodiment, a management console 330, a deployment server 304, a console proxy 320, and agents 306a-306c may reside on different computer systems, respectively. In other embodiments, various combinations of the management console 330, the deployment server 304, the console proxy 320, and the agents 306a-306c may reside on the same computer system.

As used herein, the terms “console” refers to a graphical user interface of an enterprise management system. The term “console” is used synonymously with “management console” herein. Thus, the management console 330 may be used to launch commands and manage the distributed environment monitored by the enterprise management system. The management console 330 may also interact with agents (e.g., agents 306a-306c) and may run commands and tasks on each monitored computer.

In one embodiment, the dynamic load balancing system provides the sharing of data and events, both runtime and stored, across the enterprise. Data and events may comprise objects. As used herein, an object is a self-contained entity that contains data and/or procedures to manipulate the data. Objects may be stored in a volatile memory and/or a nonvolatile memory. The objects are typically related to the monitoring and analysis activities of the enterprise management system, and therefore the objects may relate to the software and/or hardware of one or more computer systems in the enterprise. A common object system (COS) may provide a common infrastructure for managing and sharing these objects across multiple agents. As used herein, “sharing objects” may include making objects accessible to one or more applications and/or computer systems and/or sending objects to one or more applications and/or computer systems.

A common object system protocol (COSP) may provide a communications protocol between objects in the enterprise. In one embodiment, a common message layer (CML) provides a common communication interface for components. CML may support standards such as TCP/IP, SNA, FTP, and DCOM, among others. The deployment server 304 may use CML and/or the Lightweight Directory Access Protocol (LDAP) to communicate with the management console 330, the console proxy 320, and the agents 306a, 306b, and 306c.

A management console 330 is a software program that allows a user to monitor and/or manage individual computer systems in the enterprise 200. In one embodiment, the management console 330 is implemented in accordance with an industry-standard framework for management consoles such as the Microsoft Management Console (MMC) framework. MMC does not itself provide any management behavior. Rather, MMC provides a common environment or framework for snap-ins. As used herein, a “snap-in” is a module that provides management functionality. MMC has the ability to host any number of different snap-ins. Multiple snap-ins may be combined to build a custom management tool. Snap-ins allow a system administrator to extend and customize the console to meet specific management objectives. MMC provides the architecture for component integration and allows independently developed snap-ins to extend one another. MMC also provides programmatic interfaces. The MMC programmatic interfaces permit the snap-ins to integrate with the console. In other words, snap-ins are created by developers in accordance with the programmatic interfaces specified by MMC. The interfaces do not dictate how the snap-ins perform tasks, but rather how the snap-ins interact with the console.

In one embodiment, the management console is further implemented using a superset of MMC such as the BMC Management Console (BMCMC), also referred to as the BMC Integrated Console or BMC Integration Console (BMCIC). In one embodiment, BMCMC is an expansion of MMC: in other words, BMCMC implements all the interfaces of MMC, plus additional interfaces or other elements for additional functionality. Therefore, snap-ins developed for MMC may typically function with BMCMC in much the same way that they function with MMC. In other embodiments, the management console may be implemented using any other suitable standard.

As shown in FIG. 3, in one embodiment the management console 330 may include several snap-ins: a knowledge module (KM) IDE snap-in 332, an administrative snap-in 334, an event manager snap-in 336, and optionally other snap-ins 338. The KM IDE snap-in 332 may be used for building new KMs and modifying existing KMs. The administrative snap-in 334 may be used to define user groups, user roles, and user rights and also to deploy KMs and other configuration files needed by agents and consoles. The event manager snap-in 336 may receive and display events based on user-defined filters and may support operations such as event acknowledgement. The event manager snap-in 336 may also support root cause and impact analysis. The other snap-ins 338 may include snap-ins such as a production snap-in for monitoring runtime objects and a correlation snap-in for defining the relationship of objects for correlation purposes, among others. The snap-ins shown in FIG. 3 are shown for purposes of illustration and example: in various embodiments, the management console 330 may include different combinations of snap-ins, including snap-ins shown in FIG. 3 and snap-ins not shown in FIG. 3.

In various embodiments, the management console 330 may provide several functions. The console 330 may provide information relating to monitoring and may alert the user when critical conditions defined by a KM are met. The console 330 may allow an authorized user to browse and investigate objects that represent the monitored environment. The console 330 may allow an authorized user to issue and run application-management commands. The console 330 may allow an authorized user to browse events and historical data. The console 330 may provide a programmable environment for an authorized user to automate day-to-day tasks such as generating reports and performing particular system investigations. The console 330 may provide an infrastructure for running knowledge modules that are configured to create predefined views.

As stated above, an “agent”, “agent application, ” or “software agent” is a computer program that is configured to monitor and/or manage the hardware and/or software resources of one or more computer systems. The Agent may communicate with a console (e.g., the management console 330). Examples of management consoles 330 may include: a PATROL Event Manager (PEM) console, a PATROLVIEW console, and an SNMP console.

As illustrated in the embodiment of FIG. 3, agents 306a, 306b, and 306c may have various combinations of several knowledge modules: network KM 308, system KM 310, Oracle KM 312, and/or SAP KM 314. As used herein, a “knowledge module” (“KM”) is a software component that is configured to monitor a particular system or subsystem of a computer system, network, or other resource. Agents 306a, 306b, and 306c may receive information about resources running on a monitored computer system from a KM. A KM may contain actual instructions for monitoring objects or a list of KMs to load. The process of loading KMs may involve the use of an agent and a console.

A KM may generate an alarm at the console 330 when a user-defined condition is met. As used herein, an “alarm” is an indication that a parameter or an object has returned a value within the alarm range or that application discovery has discovered a missing file or process since the last application check. In one embodiment utilizing a graphical user interface (GUI), a red, flashing icon may indicate that an object is in an alarm state.

Network KM 308 may monitor network activity. System KM 310 may monitor an operating system and/or system hardware. Oracle KM 312 may monitor an Oracle relational database management system (RDBMS). SAP KM 314 may monitor a SAP R/3 system. Knowledge modules 308, 310, 312, and 314 are shown for exemplary purposes only, and in various embodiments other knowledge modules may be employed in an agent.

In one embodiment, a deployment server 304 may provide centralized deployment of software packages across the enterprise. The deployment server 304 may maintain product configuration data, provide the locations of products in the enterprise 200, maintains installation and deployment logs, and store security policies. In one embodiment, the deployment server 304 may provide data models based on a generic directory service such as the Lightweight Directory Access Protocol (LDAP).

In one embodiment, the management console 330 may access agent information through a console proxy 320. The console 330 may go through a console application programming interface (API) to send and receive objects and other data to and from the console proxy 320. The console API may be a Common Object Model (COM) API, a Common Object System (COS) API, or any other suitable API. In one embodiment, the console proxy 320 is an agent. Therefore, the console proxy 320 may have the ability to load, interpret, and execute knowledge modules.

As used herein, a “parameter” is the monitoring component of an enterprise management system, run by the Agent. A parameter may periodically use data collection commands to obtain data on a system resource and then may parse, process, and store that data on a computer running the Agent. Parameter data may be accessed via the Console (e.g., PATROLVIEW, or an SNMP Console). Parameters may have thresholds, and may trigger warnings and/or alarms. If the value returned by a parameter triggers a warning or alarm, the Agent notifies the Console and runs any recovery/reconfiguration actions specified by the parameter.

As used herein, a “collector parameter” is a type of parameter that contains instructions for gathering the values that consumer and standard parameters display.

As used herein, a “consumer parameter” is a type of parameter that only displays values that were gathered by a collector parameter, or by a standard parameter with collector properties. Consumer parameters typically do not execute commands, and typically are not scheduled for execution. However, consumer parameters may have border and alarm ranges, and may run recovery/reconfiguration actions.

As used herein, a “standard parameter” is a type of parameter that collects and displays data as numeric values or text. Standard parameters may also execute commands or gather data for consumer parameters to display.

As used herein, a “developer console” is a graphical interface to an enterprise management system. Administrators may use a developer console to manage and monitor computer instances and/or application instances. In addition, administrators may use the developer console to customize, create, and/or delete locally loaded Knowledge Modules and commit these changes to selected Agent machines.

As used herein, an “event manager” may be used to view and manage events that are sent by Agents and occur on monitored system resources on an operating system (e.g., a Unix-based or Windows-based operating system). The event manager may be accessed from the console or may be used as a stand-alone facility. The event manager may work with the Agent and/or user-specified filters to provide a customized view of events.

As used herein, a “floating board” is a system board that the KM has detected, but which is not attached to a domain. The KM gathers a list of floating boards during discovery.

As used herein, an “operator console” is a graphical interface to an enterprise management system that operators may use to monitor and manage computer instances and/or application instances.

As used herein, a “response dialog” is a graphical user interface dialog generated by a function (e.g., a PSL function) to allow for a two-way text interface between an application and its user. Response dialogs are usually displayed on a Console.

As used herein, a “System Support Processor (SSP)” is a standard Sun Ultra SPARC workstation running a standard version of Solaris, with a defined set of extension software that allows it to configure and control a Sun computer system. References to SSP throughout this document are for illustration purposes only; comparable processors and/or workstations running various other flavors of UNIX-based operating systems (e.g., HP-UX, AIX) may be substituted, as the user desires.

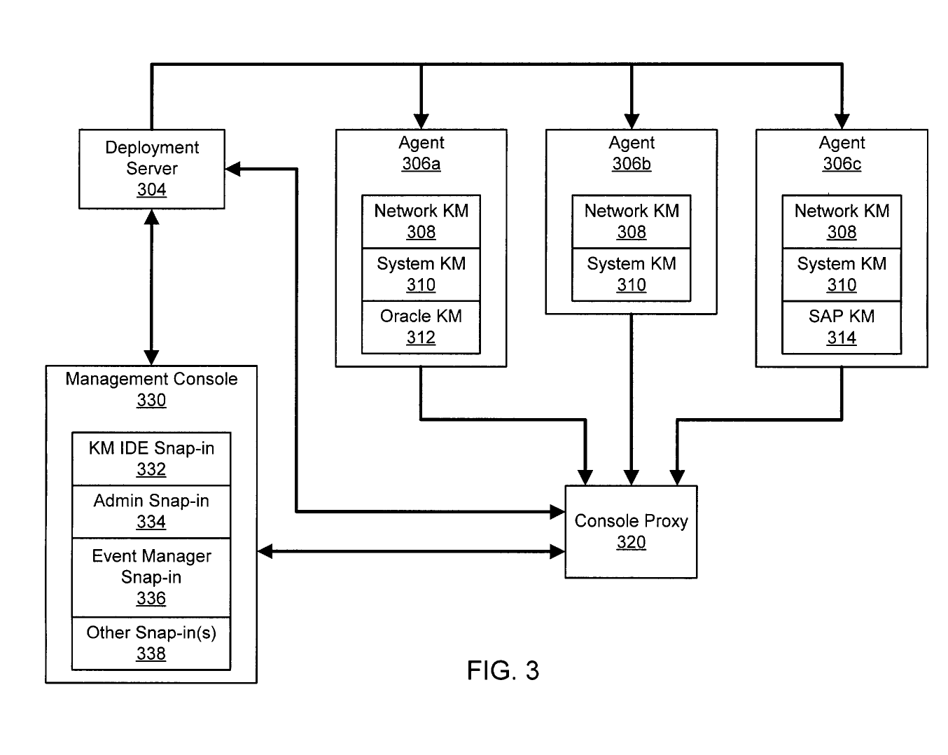

### FIG. 4—Overview of an Agent in the Enterprise Management System

FIG. 4 further illustrates some of the components that may be included in the agent 306a according to one embodiment. The agent 306a may maintain an agent namespace 350. The term “namespace” generally refers to a set of names in which all names are unique. As used herein, a “namespace” may refer to a memory, or a plurality of memories which are coupled to one another, whose contents are uniquely addressable. “Uniquely addressable” refers to the property that items in a namespace have unique names such that any item in the namespace has a name different from the names of all other items in the namespace: The agent namespace 350 may comprise a memory or a portion of a memory that is managed by the agent application 306a. The agent namespace 350 may contain objects or other units of data that relate to enterprise monitoring.

The agent namespace 350 may be one branch of a hierarchical, enterprise-wide namespace. The enterprise-wide namespace may comprise a plurality of agent namespaces as well as namespaces of other components such as console proxies. Each individual namespace may store a plurality of objects or other units of data and may comprise a branch of a larger, enterprise-wide namespace. The agent or other component that manages a namespace may act as a server to other parts of the enterprise with respect to the objects in the namespace. The enterprise-wide namespace may employ a simple hierarchical information model in which the objects are arranged hierarchically. In one embodiment, each object in the hierarchy may include a name, a type, and one or more attributes.

In one embodiment, the enterprise-wide namespace may be thought of as a logical arrangement of underlying data rather than the physical implementation of that data. For example, an attribute of an object may obtain its value by calling a function, by reading a memory address, or by accessing a file. Similarly, a branch of the namespace may not correspond to actual objects in memory but may merely be a logical view of data that exists in another form altogether or on disk.

In one embodiment, furthermore, the namespace may define an extension to the classical directory-style information model in which a first object (called an instance) dynamically inherits attribute values and children from a second object (called a prototype). This prototype-instance relationship is discussed in greater detail below. Other kinds of relationships may be modeled using associations. Associations are discussed in greater detail below.

The features and functionality of the agents may be implemented by individual components. In various embodiments, components may be developed using any suitable method, such as, for example, the Common Object Model (COM), the Distributed Common Object Model (DCOM), JavaBeans, or the Common Object System (COS). The components cooperate using a common mechanism: the namespace. The namespace may include an application programming interface (API) that allows components to publish and retrieve information, both locally and remotely. Components may communicate with one another using the API. The API is referred to herein as the namespace front-end, and the components are referred to herein as back-ends.

As used herein, a “back-end” is a software component that defines a branch of a namespace. In one embodiment, the namespace of a particular server, such as an agent 306a, may be comprised of one or more back-ends. A back-end may be a module running in the address space of the agent, or it may be a separate process outside of the agent which communicates with the agent via a communications or data transfer protocol such as the common object system protocol (COSP). A back-end, either local or remote, may use the API front-end of the namespace to publish information to and retrieve information from the namespace.

FIG. 4 illustrates several back-ends in the agent 306a. The back-ends in FIG. 4 are shown for purposes of example; in other configurations, an agent may have other combinations of back-ends. A KM back-end 360 may maintain knowledge modules that run in this particular agent 306a. The KM back-end 360 may load the knowledge modules into the namespace and schedule discovery processes with the scheduler 362 and a PATROL Script Language Virtual Machine (PSL VM) 356, a virtual machine (VM) for executing scripts. By loading a KM into the namespace, the KM back-end 360 may make the data and/or objects associated with the KM available to other agents and components in the enterprise. As illustrated in FIG. 4, another agent 306b and an external back-end 352 may access the agent namespace 350.

Other agents and components may access the KM data and/or objects in the KM branch of the agent namespace 306a through a communications or data transfer protocol such as, for example, the common object system protocol (COSP) or the industry-standard common object model (COM). In one embodiment, for example, the other agent 306b and the external back-end 352 may publish or subscribe to data in the agent namespace 350 through the common object system protocol. The KM objects and data may be organized in a hierarchy within a KM branch of the namespace of the particular agent 306a. The KM branch of the namespace of the agent 306a may, in turn, be part of a larger hierarchy within the agent namespace 350, which may be part of a broader, enterprise-wide hierarchical namespace. The KM back-end 360 may create the top-level application instance in the namespace as a result of a discovery process. The KM back-end 360 may also be responsible for loading KM configuration data.

In the same way as the KM back-end 360, other back-ends may manage branches of the agent namespace 350 and populate their branches with relevant data and/or objects which may be made available to other software components in the enterprise. A runtime back-end 358 may process KM instance data, perform discovery and monitoring, and run recovery/reconfiguration actions. The runtime back-end 358 may be responsible for launching discovery processes for nested application instances. The runtime back-end 358 may also maintain results of KM interpretation and KM runtime objects.

An event manager back-end 364 may manage events generated by knowledge modules running in this particular agent 306a. The event manager back-end 364 may be responsible for event generation, persistent caching of events, and event-related action execution on the agent 306a. A data pool back-end 366 may manage data collectors 368 and data providers 370 to prevent the duplication of collection and to encourage the sharing of data among KMs and other components. The data pool back-end 366 may store data persistently in a data repository such as a Universal Data Repository (UDR) 372. The PSL VM 356 may execute scripts. The PSL VM 356 may also comprise a script language (PSL) interpreter back-end (not shown) which is responsible for scheduling and executing scripts. A scheduler 362 may allow other components in the agent 306a to schedule tasks.

Other back-ends may provide additional functionality to the agent 306a and may provide additional data and/or objects to the agent namespace 350. A registry back-end (not shown) may keep track of the configuration of this particular agent 306a and may provide access to the configuration database of the agent 306a for other back-ends. An operating system (OS) command execution back-end (not shown) may execute OS commands. A layout back-end (not shown) may maintain GUI layout information. A resource back-end (not shown) may maintain common resources such as image files, help files, and message catalogs. A mid-level manager (MM) back-end (not shown) may allow the agent 306a to manage other agents. The mid-level manager back-end is discussed in greater detail below. A directory service back-end (not shown) may communicate with directory services. An SNMP back-end (not shown) may provide Simple Network Management Protocol (SNMP) functionality in the agent.

The console proxy 320 shown in FIG. 3 may access agent objects and send commands back to agents. In one embodiment, the console proxy 320 uses a mid-level manager (MM) back-end to maintain agents that are being monitored. Via the mid-level manager back-end, the console proxy 320 may access remote namespaces on agents to satisfy requests from console GUI modules. The console proxy 320 may implement a namespace to organize its components. The namespace of a console proxy 320 may be an agent namespace with a layout back-end mounted. Therefore, a console proxy 320 is itself an agent. The console proxy 320 may therefore have the ability to load, interpret, and/or execute KM packages. In one embodiment, the following back-ends are mounted in the namespace of the console proxy 320: KM back-end 360, runtime back-end 358, event manager back-end 364, registry back-end, OS command execution back-end, PSL interpreter back-end, mid-level manager (MM) back-end, layout back-end, and resource back-end.

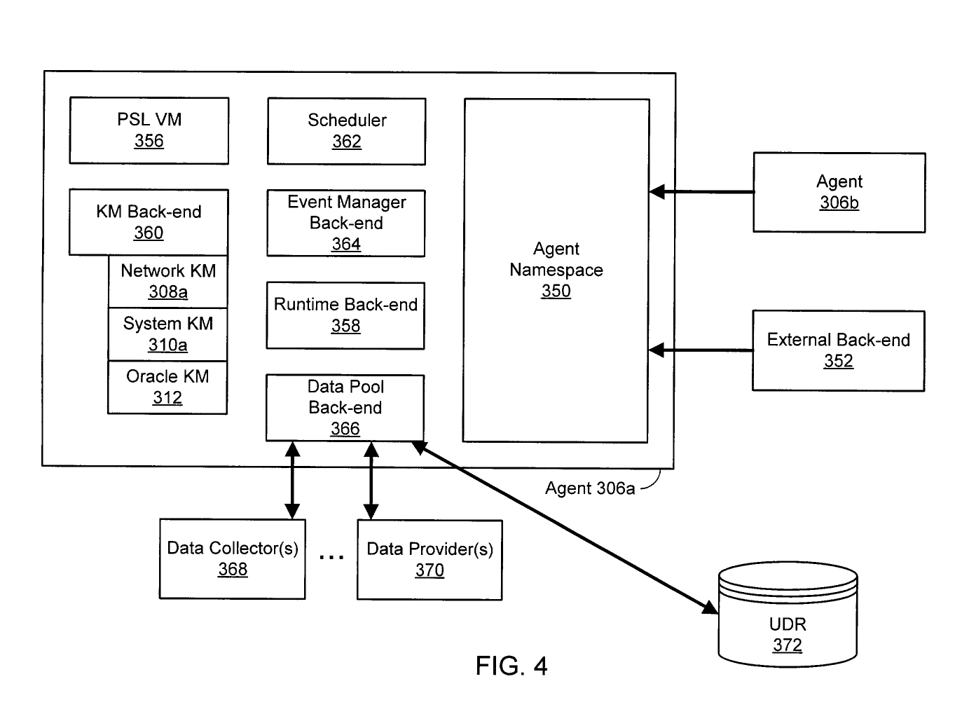

### FIG. 5—Dynamic Load Balancing

FIG. 5 is a flowchart illustrating one embodiment of dynamic load balancing a plurality of system processor boards across a plurality of domains in a first computer system. In other embodiments, the limitation of the plurality of domains residing in a single computer system may be relaxed or eliminated. A management console may communicate with the first computer system. An agent may communicate with the management console.

In step 502, the agent may gather a first set of information relating to the domains. The first set of gathered information may include a CPU load on the first computer system from each of the plurality of domains. Alternatively, or in addition, the first set of gathered information may include a rolling average CPU load on the first computer system from each of the plurality of domains. The agent may include one or more knowledge modules. Each knowledge module may be configured to gather part of the first set of information relating to the domains.

The first set of gathered information may include a prioritized list of a subset of recipient domains of the plurality of domains. Additionally, the first set of gathered information may include a prioritized list of a subset of donor domains of the plurality of domains.

The subset of recipient domains may include domains whose average CPU loads are above a user-configurable warning value and/or above a user-configurable alarm value. Typically, the user-configurable warning value is a lower value than the user-configurable alarm value.

In one embodiment, the subset of recipient domains may be sorted in descending order using domain priority as the primary sort key and CPU “overload” factor as the secondary sort key. The CPU overload factor may be computed as the difference between an average load parameter (e.g., ADRAvgLoad) and a first alarm minimum value for the average load parameter. Thus, the CPU overload factor may provide a common means to measure CPU “need” for domains which have different alarm thresholds.

For example, consider the following domains: domain A with an alarm threshold of 80, and an average load of 89, and domain B with an alarm threshold of 90 and an average load of 91. By this measure of overload, domain A is actually in greater need than domain B, even though its average load is less: (89−80)>(91−90).

The subset of donor domains may include domains with one or more of the following characteristics: average CPU load for a preceding user-configurable interval less than the minimum threshold; estimated CPU load less than a user-configurable threshold value; one or more system boards eligible to be relinquished. In one embodiment, the estimated CPU load may be calculated as: (current average CPU load * number of system boards currently assigned to the domain)/(number of system boards currently assigned to the domain−1).

In one embodiment, the subset of donor domains may be sorted in ascending order using domain priority as the primary sort key and average CPU load as the secondary sort key.

In step 504, the first set of information relating to the domains may be displayed on a management console. The user may view the information relating to the domains. As system processor boards are automatically migrated, the user may view the newly arranged system processor boards among the plurality of domains.

In step 506, one or more of the plurality of system processor boards among the plurality of domains may be automatically migrated in response to the first set of gathered information relating to the domains. A software program may execute in the management console. The software program may operate to automatically migrate system processor boards in response to the first set of gathered information relating to the domains. As used herein, the term “automatic migration” means that the migrating is performed programmatically, i.e., by software, and not in response to manual user input.

The automatic migration of one or more of the plurality of system processor boards among the plurality of domains may include: (a) selecting a highest priority available system processor board from the subset of donor domains; (b) moving the selected highest priority available system processor board from the subset of donor domains to a highest priority domain in the subset of recipient domains; (c) repeating steps (a) and (b) until supply of available system processor boards from the subset of donor domains is exhausted.

The automatic migration of one or more of the plurality of system processor boards among the plurality of domains may include: (a) selecting a highest priority available system processor board from the subset of donor domains; (b) moving the selected highest priority available system processor board from the subset of donor domains to a highest priority domain in the subset of recipient domains; (c) repeating steps (a) and (b) until demand for system processor boards in the subset of recipient domains is exhausted.

The plurality of domains may be user configurable. The user configuration may include setting characteristics for each of the plurality of domains. The characteristics may include one or more of: a priority; an eligibility for load balancing; a maximum number of system processor boards; a threshold average CPU load on the first computer system; a minimum time interval between migrations of a system processor board.

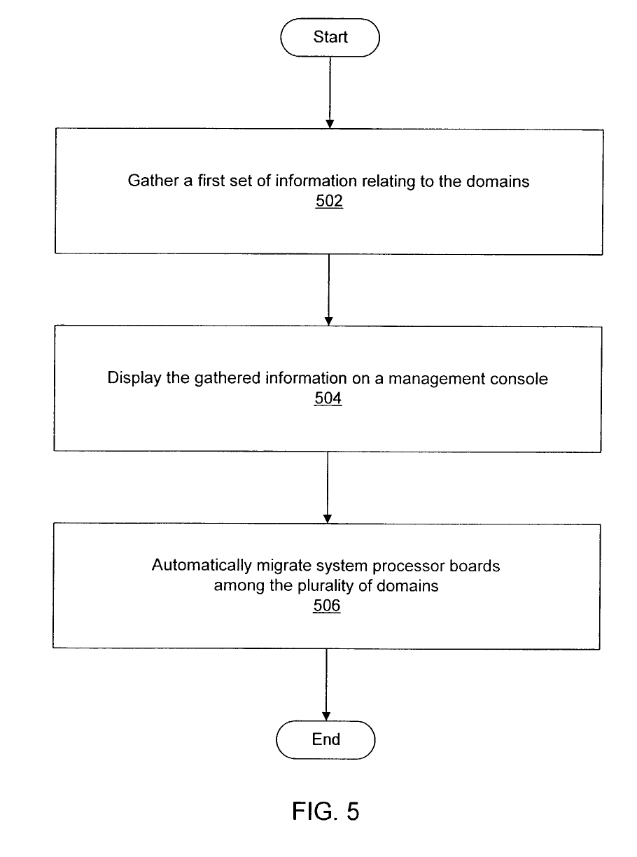

### FIG. 6—Physical Relationships

One embodiment of physical relationships of various elements of an automated domain recovery/reconfiguration (ADR) knowledge module (KM) is illustrated in FIG. 6. As used herein, an “automated domain recovery/reconfiguration” (ADR) has the capability to alter domain configuration on servers (e.g., Sun servers), and includes the software utilities used to implement the capability.

A management console (e.g., a PATROL console, as shown in the figure) may be a Microsoft Windows workstation or a Unix workstation. The management console may be coupled to an agent (e.g., an SSP PATROL agent, as shown in the figure) over a network, thus allowing communication between the management console and the agent. The agent may also be coupled to a target computer system (e.g., a Target System, as shown in the figure). Thus, through the network connections, the management console, the agent, and the target computer system may communicate.

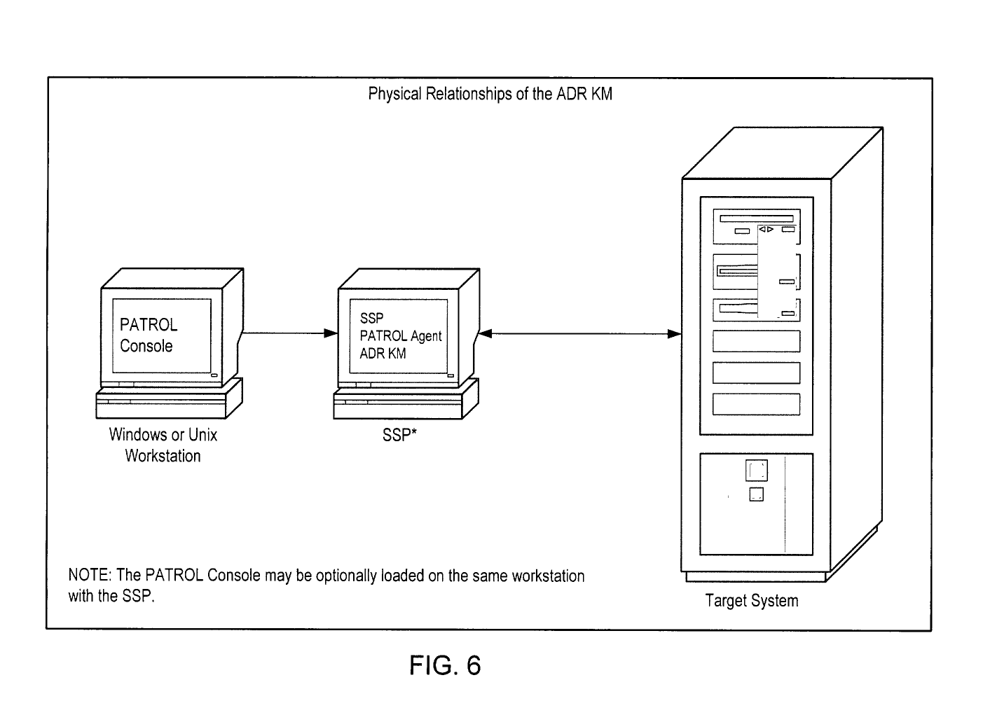

### FIG. 7—Logical Relationships

One embodiment of logical relationships of various elements of an automated domain recovery/reconfiguration (ADR) knowledge module (KM) is illustrated in FIG. 7.

One or more management consoles (e.g., PATROL consoles, as shown in the figure) may be Microsoft Windows workstations or Unix workstations. The one or more management consoles may be coupled to an agent (e.g., a PATROL agent, as shown in the figure) over a network, thus allowing communication between the one or more management consoles and the agent.

The agent may also be coupled to a target computer system (e.g., a Target System, as shown in the figure). The communication between the agent and the target computer system may involve automated domain recovery/reconfiguration (ADR) knowledge module (KM) Application Classes (e.g., ADR.km, ADR_DOMAIN.km). As used herein, an “application class” is the object class to which an application instance belongs. Additionally, a representation of an application class as a container (Unix) or folder (Windows) on the Console may be referred to as an “application class”.

In one embodiment, the ADR KM may provide automated load balancing within a server by dynamically reconfiguring domains as demand for CPU resources within the individual domains changes.

In one embodiment, the ADR KM may: automatically discover ADR hardware; automatically discover active processor boards; automatically reallocate processor boards between domains in response to changing workloads; allow the user to define and set priorities for each domain; provide the ability to set maximum and minimum load thresholds per domain (may also provide for a time delay, and/or n-number of sequential, out-of-limits samples before the threshold is considered to have been crossed); signal the need for additional resources; signal the availability of excess resources; and provide logs for detected capacity shortages, recommended or attempted ADR actions, success or failure of each step of the ADR process, and ADR process results.

Automated load balancing may be achieved by migrating system boards among domains as dictated by the system load on each domain. At discovery, the KM may attempt to assign a swap priority to the boards, based on the following characteristics of each board: domain membership, I/O ports and controllers (that are attached), and/or amount of memory. The KM may also provide a script-based response dialog that will allow the user to override default swap priorities and establish user-specified swap priorities.

In one embodiment, the KM may use CPU load of the domains as the only criterion for triggering ADR. A rolling average CPU load may be used to minimize the chance of triggering ADR as a result of a short-term spike in system load.

The communication between the agent and the target computer system may also involve System Support Processor (SSP) commands (e.g., domain_status, rstat, showusage, moveboard).

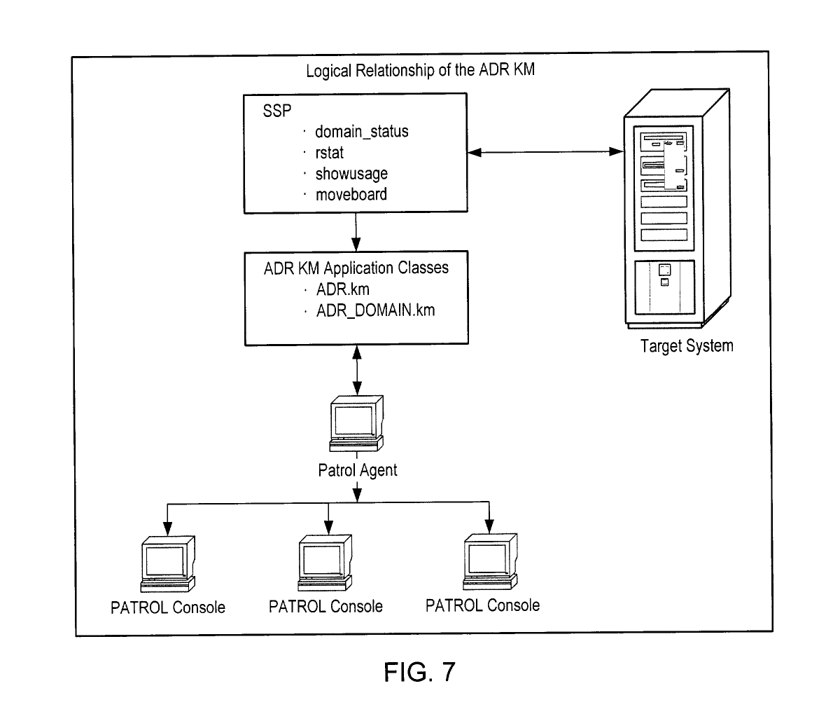

### FIG. 8—Configuration Use Case

FIG. 8 illustrates an embodiment of a configuration use case showing a first flow of events. An agent may be installed and running on a first computer system (e.g., the target computer system, as illustrated in FIGS. 6 and 7). The first computer system may be in use as an ADR controller. A console may be installed on a second computer system. The first computer system and the second computer system may be connected via a network. The ADR server or controller may be partitioned into multiple domains (e.g., development: for developing new code; builder: for compiling code into object files; batch: for running various scripts and batch jobs, typically overnight; and mail: for serving mail for the other domains). Once the ADR module or agent has been installed, it may immediately go to work balancing the load between the domains in the example “use case” scenario described below.

As shown in step 802, at the beginning of a business day (e.g., at 8:00 AM), the user may install an agent on the first computer system. For example, (1) a management console (e.g., a PATROL Console, a product of BMC Software, Inc.) may be installed and executed on the first computer system or a separate computer system coupled to the first computer system over a network; (2) an agent (e.g., a PATROL Agent, a product of BMC Software, Inc.) may be installed and executed on the first computer system. The management console and the agent may be connected via a communications link. After installation and execution, the agent may begin analysis of system and domain usage.

As used herein, a “domain” is a logical partition within a computer system that behaves like a stand-alone server computer system. Each domain may have one or more assigned processors or printed circuit boards. Examples of printed circuit boards include: boot processor boards, turbo boards, and non-turbo boards. As used herein, a “boot processor” board contains a processor used to boot a domain. As used herein, a “non-turbo” board contains one or more processors, one or more input/output (I/O) adapter cards, and/or memory. As used herein, a “turbo” board contains one or more processors but do not have I/O adapter cards or memory.

As shown in step 804, at 8:30 AM, the developers may arrive and begin working. Typically, one of the first things developers do, at the beginning of their work day, is check their e-mail. In particular, developers may check their e-mail to review the status of automated batch jobs run during the previous evening, and also to assist planning the current business day's activities for themselves and jointly with other developers. Due to the increased usage of the development domain and the mail server, the domains development and mail may request additional resources.

In one embodiment, a sorted list of donor domains may be built. As used herein, a “donor domain” is a domain that is eligible to relinquish a system board (e.g., a “non-turbo” board or a “turbo” board) for use by another domain. Conversely, a “recipient domain”) is a domain that is eligible to receive a system board donated by a donor domain. A “donor domain” may also be referred to as a “source domain”. A “recipient domain” may also be referred to as a “target domain”.

It is noted that a “boot processor” board is not a good candidate for donation as “boot processor” boards contain a processor used to boot a domain. Thus, non-boot processor boards are typically donated or swapped, rather than boot processor boards. An example of priority settings for various system boards follows (where a higher priority setting number indicates a higher priority of being swapped): priority setting 0 for a boot processor board; priority setting 1 for a non-turbo system board (with memory and I/O adapters); priority setting 2 for a non-turbo system board (with I/O adapters, but without memory); priority setting 3 for a non-turbo system board (with memory, but without I/O adapters); priority setting 4 for a turbo system board (with no memory and with no I/O adapters). In one embodiment, the priority setting at which a board is considered swappable may be user configured. Thus, if the user sets the minimum priority setting for swappability at 4, only turbo system boards would be candidates for donation.

In order to be classified as a recipient domain, a domain may need to meet certain criteria. The criteria may be user configurable. One set of criteria for a recipient domain may include: (1) automated dynamic reconfiguration (ADR) enabled; (2) less than a maximum number of system boards that are allowed in a domain (i.e., per the configuration of the domain); (3) a higher CPU load average than the user configured threshold CPU load average; (4) no previous participation in another “board swapping” operation within a user configured minimum time interval.

When a recipient domain is identified, a search for a donor domain may begin. The search for a donor board within a donor domain may proceed through a series of characteristics ranging from most desirable donor boards to least desirable donor boards. One example series may be: (1) a system board that has no domain assignment; (2) a “swap-eligible” system board currently assigned to any domain other than the recipient domain.

One set of criteria for determining whether a domain has any “swap-eligible” system boards may include the following domain characteristics: (1) automated dynamic reconfiguration (ADR) enabled; (2) one or more system boards that have a priority which allows the system boards to be swapped into another domain (i.e., priority of a system board may be a user configurable setting; priority may be based on characteristics of a system board, as described below); (3) estimated CPU load less than the user configured minimum CPU load or user configured domain priority less than the user configured domain priority of the recipient domain; (4) estimated average CPU load less than the user configured estimated maximum CPU load; (5) no previous participation in another “board swapping” operation (i.e., receiving or donating) within a user configured minimum time interval.

In addition to maximum CPU load average thresholds, minimum CPU load average thresholds may also be configured by the user. In addition to CPU load averages, other user defined measures may be used, with minimum and maximum values allowable for each user defined measure. In one embodiment, user settings for time delays and/or n-number of sequential, out-of-limits samples may further limit the determination of whether a particular threshold has been reached or crossed.

In the case where the first computer system is either maxed out or under-utilized, the dynamic load balancing system and method may indicate a need for additional resources (e.g., system boards), or an availability of excess resources, respectively.

The priority or “swap” priority of each system board may be based on the following system board characteristics, among others (e.g., user defined characteristics): domain membership, attached input/output (I/O) ports and/or controllers, amount of memory.

Logs may be maintained by the dynamic load balancing system and method. Reasons to keep logs may include, but are not limited to, the following: (1) to detect capacity shortages; (2) to record recommended or attempted actions; (3) to record success or failure of each step of the process; (4) to record process results.

As shown in step 806, at 9:00 AM, the developers may begin coding and testing on development (i.e., using the development domain). Due to an increase in usage on the development domain, the development domain may request additional resources (e.g., system boards).

As shown in step 808, at 11:30 AM, the developers may stop coding and start a first build on builder (i.e., using the builder domain). Due to an increase in usage on the builder domain, the builder domain may request additional resources (e.g., system boards).

As shown in step 810, at 1:00 PM, the developers may resume coding on development (i.e., using the development domain). Due to an increase in usage on the development domain, the development domain may request additional resources (e.g., system boards).

As shown in step 812, at 4:00 PM, the developers may stop coding and start a second build on builder (i.e., using the builder domain). Due to an increase in usage on the builder domain, the builder domain may request additional resources (e.g., system boards).

As shown in step 814, at 6:00 PM, the developers may stop coding and may check their e-mail before leaving for the day. Due to an increase in usage on the mail domain, the mail domain may request additional resources (e.g., system boards).

As shown in step 816, at 8:00 PM, the automated batch scripts may start on the batch domain. Due to an increase in usage on the batch domain, the batch domain may request additional resources (e.g., system boards).

As shown in step 818, at 11:00 PM, the automated batch scripts may complete; the batch jobs may then send e-mail to the developers with their results. Due to an increase in usage on the mail domain, the mail domain may request additional resources (e.g., system boards).

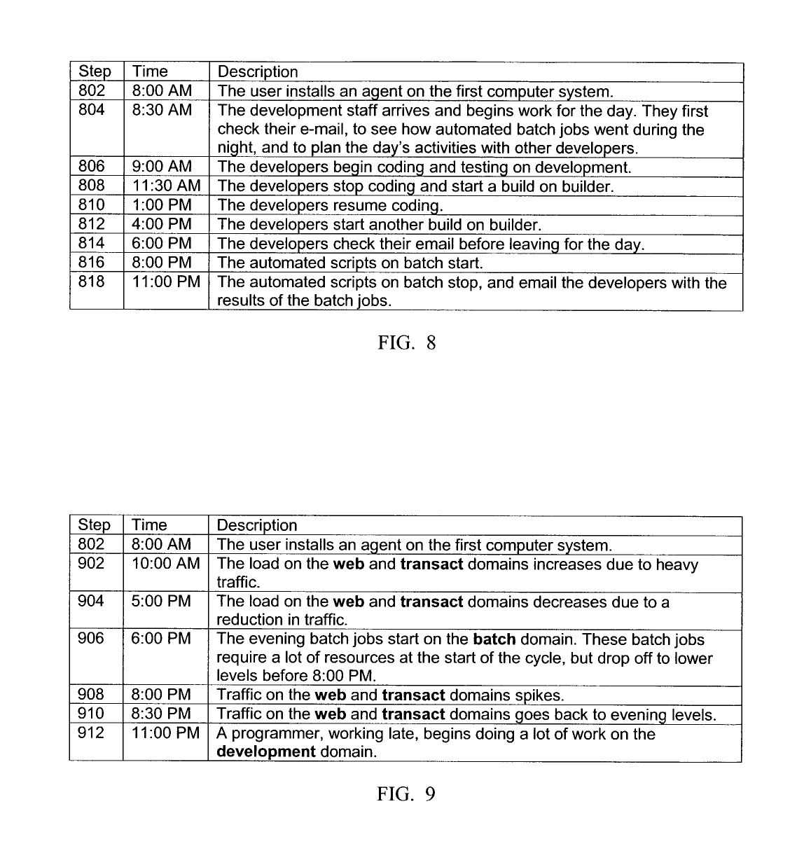

### FIG. 9—KM Tiered Use Case

FIG. 9 illustrates an embodiment of a KM tiered use case showing a second flow of events. Similar to the use case described in FIG. 8, an agent may be installed and running on a first computer system (e.g., the target computer system, as illustrated in FIGS. 6 and 7). The first computer system may be in use as an ADR controller. A console may be installed on a second computer system. The first computer system and the second computer system may be connected via a network. The ADR server or controller may be partitioned into multiple domains (e.g., web: for serving web pages for the site (e.g., an electronic commerce (e-commerce) site); transact: for running the database for the site; batch: for running various scripts and batch jobs, typically overnight; and development: for developing code). Once the ADR module has been configured for prioritizing load balancing, it may then better allocate resources to an ADR setup in the example “use case” scenario described below.

As shown in step 802, at the beginning of a business day (e.g., at 8:00 AM), the user may install an agent on the first computer system. For example, (1) a management console (e.g., a PATROL Console, a product of BMC Software, Inc.) may be installed and executed on the first computer system or a separate computer system coupled to the first computer system over a network; (2) an agent (e.g., a PATROL Agent, a product of BMC Software, Inc.) may be installed and executed on the first computer system. The management console and the agent may be connected via a communications link. After installation and execution, the agent may begin analysis of system and domain usage.

As shown in step 902, at 10:00 AM, increased traffic on the web domain and/or the transact domain may cause an increase in system loads. Due to the increased usage of the web domain and/or the transact domain, the domains web and transact may request additional resources.

As the usage increases, the rolling average (e.g., represented by an average load parameter) may also increase to a point where the web domain and/or the transact domain go into an alarm state. With the need for boards evident, a daemon (e.g., the ADRDaemon) may begin collecting information on which domains need resources, and which domains have available resources.

The daemon may build a request list based on domain priority and usage. In this example, the list may contain the web domain and the transact domain. The distribution of available boards to domains may be based on a priority value or ranking associated with each domain. The daemon may also build a sorted list of donor domains. For example, boards in the development domain may be available for donation. The daemon may go through the list of donor boards and may assign one or more to each of the recipient domains (i.e., the web domain and the transact domain), as needed.

A domain may remain in an alarm state if the number of recipient domains exceeds the number of donor boards available. In this case, a user-configurable notification (e.g., an e-mail or a page) may be generated, indicating the shortage of resources.

As shown in step 904, at 5:00 PM, reduced traffic on the web domain and/or the transact domain may cause a decrease in system loads. Due to the decreased usage of the web domain and/or the transact domain, any outstanding requests for additional resources for the domains web and transact may be deleted, thus causing any current alarm conditions to be reset to a normal condition, as no additional resources are currently required.

As shown in step 906, at 6:00 PM, automated batch scripts may start on the batch domain. Due to an increase in usage on the batch domain, the batch domain may request additional resources (e.g., system boards). The batch domain may stay in an alarm state, even if donor boards are found and allocated to the batch domain, if the load on the batch domain remains high. In this case, another request list based on domain priority and usage may be constructed, with the possible outcome being that the batch domain receives an additional board from a donor domain.

As shown in step 908, at 8:00 PM, a lull in the batch processes accompanied by a brief surge in web traffic may result in a need for resources in the web domain and/or the transact domain.

As shown in step 910, at 8:30 PM, the brief surge in web traffic may cease, thus the need for resources in the web domain and/or the transact domain may no longer exist, and the daemon may go out of alarm state (i.e., return to normal state).

As shown in step 912, at 11:00 PM, a programmer, working late, may cause a surge in activity on the development domain. This increased activity on the development domain may result in a need for resources in the development domain.

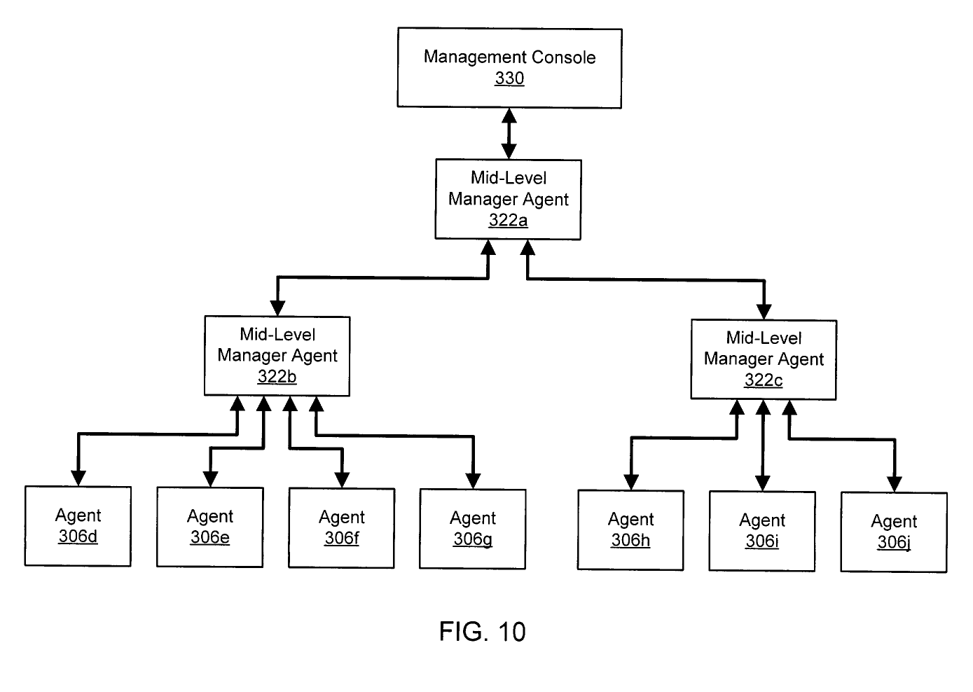

### FIG. 10—Enterprise Management System Including Mid-Level Managers

In one embodiment, the dynamic load balancing system and method may also include one or more mid-level managers. In one embodiment, a mid-level manager is an agent that has been configured with a mid-level manager back-end. The mid-level manager may be used to represent the data of multiple managed agents. FIG. 10 illustrates an enterprise management system including a plurality of mid-level managers according to one embodiment. A management console 330 may exchange data with a higher-level mid-level manager agent 322a. The higher-level mid-level manager agent 322a may manage and consolidate information from lower-level mid-level manager agents 322b and 322c. The lower-level mid-level manager agents 322b and 322c may then manage and consolidate information from a plurality of agents 306d through 306j. In one embodiment, the dynamic load balancing system may include one or more levels of mid-level manager agents and one or more other agents.

### Advantages of Mid-Level Managers

The use of a mid-level manager may tend to bring many advantages. First, it may be desirable to funnel all traffic via one connection rather than through many agents. Use of only one connection between a console and a mid-level manager agent may therefore result in improved network efficiency.

Second, by combining the data on the multiple managed agents to generate composite events or correlated events, the mid-level manager may offer an aggregated view of data. In other words, an agent or console at an upper level may see the overall status of lower levels without being concerned about individual agents at those lower levels. Although this form of correlation could also occur at the console level, performing the correlation at the mid-level manager level tends to confer benefits such as enhanced scalability.

Third, the mid-level manager may offer filtered views of different levels, from enterprise levels to detailed system component levels. By filtering statuses or events at different levels, a user may gain different views of the status of the enterprise.

Fourth, the addition of a mid-level manager may offer a multi-tiered approach towards deployment and management of agents. If one level of mid-level managers is used, for example, then the approach is three-tiered. Furthermore, a multi-tiered architecture with an arbitrary number of levels may be created by allowing inter-communication between various mid-level managers. In other words, a higher level of mid-level managers may manage a lower level of mid-level managers, and so on. This multi-tiered architecture may allow one console to manage a large number of agents more easily and efficiently.

Fifth, the mid-level manager may allow for efficient, localized configuration. Without a mid-level manager, the console must usually provide configuration data for every agent. For example, the console would have to keep track of valid usernames and passwords on every managed machine in the enterprise. With a multi-tiered architecture, however, several mid-level managers rather than a single, centralized console may maintain configuration information for local agents. With the mid-level manager, therefore, the difficulties of maintaining such centralized information may in large part be avoided.

### Mid-Level Manager Back-end

In one embodiment, mid-level manager functionality may be implemented through a mid-level manager back-end. The mid-level manager back-end may be included in any agent that is desired to be deployed as a mid-level manager. In one embodiment, the top-level object of the mid-level manager back-end may be named “MM”. The agents managed by a mid-level manager may be referred to as “sub-agents”. As used herein, a “sub-agent” is an agent that implements lower-level namespace tiers for a master agent. An agent may be called a master agent with respect to its sub-agents. An agent with its namespace tier in the middle of an enterprise-wide namespace is thus a master agent and a sub-agent.

The mid-level manager back-end may maintain a local file called a sub-agent profile to keep track of sub-agents. When a mid-level manager starts, it may read the sub-agent profile file and, if specified in the profile, connect to sub-agents via a “mount” operation provided by the common object system protocol. The profile may be set up by an administrator in a deployment server and deployed to the mid-level manager.

For each sub-agent managed by the mid-level manager, a proxy object may be created under the top-level object “MM.” Proxy objects are entry points to namespaces of sub-agents. In the mid-level manager, objects such as back-ends in sub-agents may be accessed by specifying a pathname of the form “/MM/sub-agent-name/object-name/ . . . ”. The following events may be published on proxy objects to notify back-end clients: connect, disconnect, connection broken, and hang-up, among others. The connect event may notify clients that the connection to a sub-agent has been established. The disconnect event may notify clients that a sub-agent has been disconnected according to a request from a back-end. The connection broken event may notify clients that the connection to a sub-agent has been broken due to network problems. The hang-up event may notify clients that the connection to a sub-agent has been broken by the sub-agent.

In one embodiment, the mid-level manager back-end may accept the following requests from other back-ends: connect, disconnect, register interest, and remove interest, among others. The “connect” request may establish a connection to a sub-agent. In the profile, the sub-agent may then be marked as “connected”. The “disconnect” request may disconnect from a sub-agent. In the profile, the sub-agent may then be marked as “disconnected.” The “register interest” request may have the effect of registering interest in a knowledge module (KM) package in a sub-agent. The KM package may then be recorded in the profile for the sub-agent. The “remove interest” request may have the effect of removing interest in a KM package in a sub-agent. The KM package may then be removed from the profile of the sub-agent.

The mid-level manager back-end may provide the functionality to add a sub-agent, remove a sub-agent, save the current set of sub-agents to the sub-agent profile, load sub-agents from the sub-agent profile, connect to a sub-agent, disconnect from a sub-agent, register interest in a KM package in a sub-agent, remove interest in a KM package in a sub-agent, push KM packages to sub-agents in development mode for KM development, erase KM packages from sub-agents in development mode, among other functionality.

The mid-level manager back-end may have two object classes: “mmManager” and “mmProxy.” An “mmManager” object may keep track of a set of “mmProxy” objects. An “mmManager” object may be associated with a sub-agent profile. An “mmproxy” object may represent a sub-agent in a master agent. The mid-level manager back-end may be the entry point to the namespace of the sub-agent. In one embodiment, most of the mid-level manager functionality may be implemented by these objects.

### The “mmManager” Object

In the mid-level manager back-end of a master agent, multiple “mmManager” objects may be created to represent different domains of sub-agents, respectively. An “mmManager” object may be the root object of a mid-level manager back-end instance. In one embodiment, an “mmManager” class corresponding to the “mmManager” object is derived from a “Cos_VirtualObject” class. The name of an “mmManager” object may be set to “MM” by default. In one embodiment, it may be set to any valid Common Object System (COS) object name as long as the name is unique among other COS objects under the same parent object.

A sub-agent may be added to a MM back-end by calling the “createObject” method of its “mmManager” object. This method may support creating an “mmProxy” object as a child of the “mmManager” object. In one embodiment, an “mmProxy” object may have a name that is unique among “mmProxy” objects under the same “mmManager” object. A sub-agent may be removed from an MM back-end by calling the “destroyObject” method of its associated “mmManager” object.

After an “mmManager” object is created, the “load” method may be called to load the associated sub-agent profile. The “load” method may be available via a COS “execute” call. In one embodiment, a sub-agent profile is a text file with multiple instances representing sub-agents. A sub-agent is represented as an instance. An instance may have multiple attributes (e.g., a class definition of the “mmProxy” object).

In one embodiment, if “*” is used in both the “included KM packages” and the “excluded KM packages” fields, the “*” in “excluded KM packages” field takes precedence. That is, no KM packages will be of interest for that sub-agent.

In one embodiment, the “mmManager” object supports the “save” method to save sub-agent information to the associated sub-agent profile file. The “save” method may be available via a COS “execute” call. When the “save” method is called, the “mmManager” object may scan children that are “mmProxy” objects. For each “mmProxy” child, an instance may be printed. The “mmManager” object may use a dirty bit to synchronize itself with the associated sub-agent profile.

### The “mmProxy” Object

An “mmProxy” object may provide the entry point to the namespace of the sub-agent that it represents. The “mmProxy” object may be derived from the COS mount object. Typically, the name of an “mmProxy” object matches the name of the corresponding sub-agent.

After an “mmProxy” object is created, the “connect” method may be called to connect to the sub-agent. The connection state attribute may be updated to reflect the progress of the connect progress. In one embodiment, when a non-zero heartbeat time is given, an “mmProxy” object may periodically check the connection with the sub-agent. If the sub-agent does not reply in the heartbeat time, the “BROKEN” connection state is reached. Setting this attribute to zero disables the heartbeat checking. The user name given in the user ID attribute may be used to obtain an access token to access the sub-agent's namespace. The privilege of the master agent in the sub-agent may be determined by the sub-agent using the access token. The “disconnect” method may be called to disconnect from the sub-agent.

An “mmProxy” object may keep track of KM packages that are available in the corresponding sub-agent and that are of interest to the master agent. The “included KM packages” and “excluded KM packages” attributes may be initialized when the “mmProxy” object is loaded from the sub-agent profile. The “included KM packages” and “excluded KM packages” attributes may be empty if the “mmProxy” object is created after the sub-agent profile is loaded. The “effective KM packages” attribute may be determined based on the value of the “included KM packages” and the “excluded KM packages” attributes.

In one embodiment, the “mmProxy” object may support four methods for KM package management: “register”, “remove”, “include” and “exclude”, among others. These methods may be available via a COSP “execute” call. Calling “register” may add a KM package to the effective KM package list, if the KM package is not already in the list. The KM package may be optionally added to the “included KM packages” list. Calling “remove” may remove a KM package from the effective KM package list, and optionally add it to the “excluded KM packages” list. In both methods, the KM package may be given as the first argument of the “execute” call. The second argument may specify whether to add the KM package to the “included/excluded KM packages” list. Calling “include” may add a KM package to the “included KM packages” list if it is not already in the list. Calling “exclude” may add a KM package to the “excluded KM packages” list if it is not already in the list. In one embodiment, the KM package is given as the first argument of the “execute” call. Optionally, a second argument may be used to specify whether a replace operation should be performed instead of an add operation. If the “included/excluded KM packages” list is changed by a call, the “effective KM packages” may be recalculated based on the mentioned rules. When the “effective KM packages” list is changed, the “mmProxy” object may communicate to the KM back-end of the sub-agent to adjust the KM interest of the master agent, which is described below.

When an “mmProxy” object successfully connects to the corresponding sub-agent, it may register KM interest in the sub-agent based on the value of its “effective KM packages” attribute. For each effective KM package, the “mmProxy” object may issue a “register” COSP “execute” call on the remote “/KM” object, passing the KM package name as the first argument. Upon receiving this call, the KM back-end in the sub-agent may load the KM package if it is not already loaded and may initiate discovery processes.

The “mmProxy” object may have a class-wide event handler to watch the value of the “effective KM packages” attributes of “mmProxy” objects. This event handler may subscribe to “Cos_SetEvent” events on that attribute. Upon receiving a “Cos_SetEvent” event, this event handler may perform the following actions. For each KM package that is included in the “old value” and is not included in the “new value” of the attribute, the event handler may issue a “remove” COSP “execute” call on the remote “/KM” object. For each KM package that is not included in the “old value” and is included in the “new value” of the attribute, the event handler may issue a “register” COSP “execute” call on the remote “/KM” object.

### The Agent API and the MM Back-end

The MM back-end may also provide a programming interface for client access to agents. A client that desires to access information in agents may be implemented using the COS-COSP infrastructure discussed above. With a namespace established, it then may mount MM back-ends into the namespace. If the mount operations are successful, then the client has full access to namespaces of sub-agents under security constraints.

In one embodiment, the API to access sub-agents is the COS API, including methods such as “get”, “set”, “publish”, “subscribe”, “unsubscribe”, and “execute”, among others. Full path names may be used to specify objects in sub-agents. Using “subscribe”, a client may obtain events published in the namespaces of sub-agents. Using “set” and “publish”, a client may trigger activities in sub-agents. In one embodiment, performance enhancement may be achieved by introducing a caching mechanism into COSP.

In one embodiment, before this API is available to a client, the client must be authenticated with a security mechanism. The client must provide identification information to be verified that it is a valid user in the system. In one embodiment, the procedure for a client program to establish access to agents is summarized as follows. A COS namespace may be created. An access token may be obtained by completing the authentication process. MM back-ends may be mounted, and sub-agent profiles may be loaded. The client program may connect to sub-agents. The client program may then start accessing objects in sub-agents using the COS API.

Various embodiments further include receiving or storing instructions and/or data implemented in accordance with the foregoing description upon a carrier medium. Suitable carrier mediums include storage mediums such as magnetic or optical media, e.g., disk or CD-ROM, as well as signals or transmission media such as electrical, electromagnetic, or digital signals, conveyed via a communication medium such as networks 202 and 204 and/or a wireless link.

Although the system and method of the present invention have been described in connection with several embodiments, the invention is not intended to be limited to the specific forms set forth herein, but on the contrary, it is intended to cover such alternatives, modifications, and equivalents, as can be reasonably included within the spirit and scope of the invention as defined by the appended claims.

What is claimed is:

1. A method for dynamic load balancing a plurality of system processor boards across a plurality of domains in a first computer system, the method comprising:
gathering a first set of information relating to the plurality of domains using an agent;
automatically migrating one or more of the plurality of system processor boards among the plurality of domains in response to the first set of gathered information relating to the plurality of domains;
wherein said automatic migration operates to dynamic load balance the plurality of system processor boards.

2. The method of claim 1, further comprising:
displaying the first set of gathered information relating to the plurality of domains on a management console wherein the management console is coupled to the first computer system.

3. The method of claim 1, wherein the first set of gathered information comprises a CPU load on the first computer system from each of the plurality of domains.

4. The method of claim 1, wherein the first set of gathered information comprises a rolling average CPU load on the first computer system from each of the plurality of domains.

5. The method of claim 1, wherein the agent comprises one or more knowledge modules, wherein each knowledge module is configured to gather part of the first set of information relating to the domains.

6. The method of claim 1, wherein the first set of gathered information comprises a prioritized list of a subset of recipient domains of the plurality of domains.

7. The method of claim 6, wherein the first set of gathered information comprises a prioritized list of a subset of donor domains of the plurality of domains.

8. The method of claim 7, wherein automatically migrating one or more of the plurality of system processor boards among the plurality of domains further comprises:
a. selecting a highest priority available system processor board from the subset of donor domains;
b. moving the selected highest priority available system processor board from the subset of donor domains to a highest priority domain in the subset of recipient domains;
c. repeating steps (a) and (b) until supply of available system processor boards from the subset of donor domains is exhausted.

9. The method of claim 7, wherein automatically migrating one or more of the plurality of system processor boards among the plurality of domains further comprises:
a. selecting a highest priority available system processor board from the subset of donor domains;
b. moving the selected highest priority available system processor board from the subset of donor domains to a highest priority domain in the subset of recipient domains;
c. repeating steps (a) and (b) until demand for system processor boards in the subset of recipient domains is exhausted.

10. The method of claim 1, wherein the plurality of domains are user configurable.

11. The method of claim 10, wherein the user configuration comprises setting characteristics for each of the plurality of domains, wherein the characteristics comprise one or more of:
a priority;
an eligibility for load balancing;
a maximum number of system processor boards;
a threshold average CPU load on the first computer system;
a minimum time interval between migrations of a system processor board.

12. A method for dynamic load balancing a plurality of system processor boards across a plurality of domains, the method comprising:
gathering a first set of information relating to the plurality of domains using an agent;
automatically migrating one or more of the plurality of system processor boards among the plurality of domains in response to the first set of gathered information relating to the plurality of domains;
wherein said automatic migration operates to dynamic load balance the plurality of system processor boards.

13. The method of claim 12, further comprising:
displaying the first set of gathered information relating to the plurality of domains on a management console.

14. A system for dynamic load balancing a plurality of system processor boards across a plurality of domains in a first computer system, the system comprising:
a CPU coupled to the first computer system;
a system memory coupled to the CPU, wherein the system memory stores one or more computer programs executable by the CPU;
wherein the computer programs are executable to:
gather a first set of information relating to the plurality of domains using an agent;
automatically migrate one or more of the plurality of system processor boards among the plurality of domains in response to the first set of gathered information relating to the plurality of domains;
wherein said automatic migration operates to dynamic load balance the plurality of system processor boards.

15. The system of claim 14, wherein the computer programs are further executable to:
display the first set of gathered information relating to the plurality of domains on a management console wherein the management console is coupled to the first computer system.

16. The system of claim 14, wherein the first set of gathered information comprises a CPU load on the first computer system from each of the plurality of domains.

17. The system of claim 14, wherein the first set of gathered information comprises a rolling average CPU load on the first computer system from each of the plurality of domains.

18. The system of claim 14, wherein the agent comprises one or more knowledge modules, wherein each knowledge module is configured to gather part of the first set of information relating to the domains.

19. The system of claim 14, wherein the first set of gathered information comprises a prioritized list of a subset of recipient domains of the plurality of domains.

20. The system of claim 19, wherein the first set of gathered information comprises a prioritized list of a subset of donor domains of the plurality of domains.

21. The system of claim 20, wherein in automatically migrating one or more of the plurality of system processor boards among the plurality of domains, the computer programs are further executable to:
a. select a highest priority available system processor board from the subset of donor domains;
b. move the selected highest priority available system processor board from the subset of donor domains to a highest priority domain in the subset of recipient domains;
c. repeat steps (a) and (b) until supply of available system processor boards from the subset of donor domains is exhausted.

22. The system of claim 20, wherein in automatically migrating one or more of the plurality of system processor boards among the plurality of domains, the computer programs are further executable to:
a. select a highest priority available system processor board from the subset of donor domains;
b. move the selected highest priority available system processor board from the subset of donor domains to a highest priority domain in the subset of recipient domains;
c. repeat steps (a) and (b) until demand for system processor boards in the subset of recipient domains is exhausted.

23. The system of claim 14, wherein the plurality of domains are user configurable.

24. The system of claim 23, wherein the user configuration comprises setting characteristics for each of the plurality of domains, wherein the characteristics comprise one or more of:
a priority;
an eligibility for load balancing;
a maximum number of system processor boards;
a threshold average CPU load on the first computer system;
a minimum time interval between migrations of a system processor board.

25. A carrier medium which stores program instructions, wherein the program instructions are executable to implement:
gathering a first set of information relating to the plurality of domains using an agent;
automatically migrating one or more of the plurality of system processor boards among the plurality of domains in response to the first set of gathered information relating to the plurality of domains;
wherein said automatic migration operates to dynamic load balance the plurality of system processor boards.

26. The carrier medium of claim 25, wherein the program instructions are further executable to implement:
displaying the first set of gathered information relating to the plurality of domains on a management console wherein the management console is coupled to the first computer system.

27. The carrier medium of claim 25, wherein the first set of gathered information comprises a CPU load on the first computer system from each of the plurality of domains.

28. The carrier medium of claim 25, wherein the first set of gathered information comprises a rolling average CPU load on the first computer system from each of the plurality of domains.

29. The carrier medium of claim 25, wherein the agent comprises one or more knowledge modules, wherein each knowledge module is configured to gather part of the first set of information relating to the domains.

30. The carrier medium of claim 25, wherein the first set of gathered information comprises a prioritized list of a subset of recipient domains of the plurality of domains.

31. The carrier medium of claim 30, wherein the first set of gathered information comprises a prioritized list of a subset of donor domains of the plurality of domains.

32. The carrier medium of claim 31, wherein in automatically migrating one or more of the plurality of system processor boards among the plurality of domains, the program instructions are further executable to implement:
a. selecting a highest priority available system processor board from the subset of donor domains;
b. moving the selected highest priority available system processor board from the subset of donor domains to a highest priority domain in the subset of recipient domains;
c. repeating steps (a) and (b) until supply of available system processor boards from the subset of donor domains is exhausted.

33. The carrier medium of claim 31, wherein in automatically migrating one or more of the plurality of system processor boards among the plurality of domains, the program instructions are further executable to implement:
a. selecting a highest priority available system processor board from the subset of donor domains;
b. moving the selected highest priority available system processor board from the subset of donor domains to a highest priority domain in the subset of recipient domains;
c. repeating steps (a) and (b) until demand for system processor boards in the subset of recipient domains is exhausted.

34. The carrier medium of claim 25, wherein the plurality of domains are user configurable.

35. The carrier medium of claim 34, wherein the user configuration comprises setting characteristics for each of the plurality of domains, wherein the characteristics comprise one or more of:
a priority;
an eligibility for load balancing;
a maximum number of system processor boards;
a threshold average CPU load on the first computer system;
a minimum time interval between migrations of a system processor board.

36. The carrier medium of claim 25, wherein the carrier medium is a memory medium.
